(19) United States
(12) Patent Application Publication
(10) Pub. No.: US 2026/0187282 A1
(43) Pub. Date: Jul. 2, 2026

(54) MACHINE LEARNING-BASED IMAGE STEGANOGRAPHY OBFUSCATION

(71) Applicant: Palo Alto Networks, Inc., Santa Clara, CA (US)

(72) Inventors: Qian Feng, Mountain View, CA (US); Yuwen Dai, Santa Clara, CA (US); Qi Zhang, Saratoga, CA (US); Shengming Xu, San Jose, CA (US); Curtis Leland Carmony, Albuquerque, NM (US); Yanhui Jia, San Jose, CA (US); Qi Deng, Sunnyvale, CA (US); Yu Fu, Sunnyvale, CA (US); Suiqiang Deng, Fremont, CA (US); Chien-Hua Lu, San Jose, CA (US); Christian Elihu Navarrete Discua, San Jose, CA (US)

(21) Appl. No.: 19/005,675

(22) Filed: Dec. 30, 2024

(51) Int. Cl. G06F 21/62; G06F 7/58

(52) U.S. Cl. CPC G06F 21/6254; G06F 7/58

(57) ABSTRACT

An image transform model and an image recovery model in the present disclosure are trained to obfuscate hidden malicious payloads in original images and recover the original images from the obfuscated/transformed images, respectively. The image transform model is trained on known malicious images as an ensemble with an adversarial discriminator that predicts whether malicious payloads are recoverable from transformed images output by the image transform model. The trained image transform model is then fixed and used to generate transformed images from the known malicious images, and the transformed images are used as training data for the image recovery model to recover the corresponding (original) known malicious images.

### BACKGROUND

The disclosure generally relates to data processing (e.g., CPC subclass G06F) and to computing arrangements based on specific computational models (e.g., CPC subclass G06N).

Most image file formats include image headers, image metadata, and image pixel data. Image steganography is a technique for hiding data within pixel data of an image for potentially malicious purposes. Common image steganography techniques include the least significant bit (LSB) method, which adds the hidden data as alterations of LSBs for individual pixels in images, and transform domain techniques which transform images into a different domain (e.g., using wavelet transforms), alter the transformed images, and apply the inverse transform to revert the transformed/altered images back to the original domain. Image steganography is used for both benign purposes such as digital watermarking and malicious purposes such as hiding malicious payloads that are executed when an image is rendered.

Content disarm and reconstruction (CDR) is a technique for intercepting potentially malicious files, removing potentially malicious code from the intercepted files, and reconstructing the files with the code removed before forwarding the reconstructed files to their intended destinations. CDR can be applied to files from various data sources such as emails, public to private network communications, etc., and to files of various formats such as image files, Portable Document Format (PDF) files, etc. Reconstruction techniques depend on formats of the files and involve reconstructing files in such a way that each file maintains a valid format post reconstruction.

### BRIEF DESCRIPTION OF THE DRAWINGS

Embodiments of the disclosure may be better understood by referencing the accompanying drawings.

FIG. 1 is a schematic diagram of an example system for training an image transform model and an image recovery model for transforming images to obfuscate hidden malicious payloads and recovering original images from transformed images.

FIG. 2 is a flowchart of example operations for training an image transform model and an image recovery model to obfuscate hidden malicious payloads by transforming images and recovering original images from the transformed images.

FIG. 3 is a flowchart of example operations for training an image recovery model to recover original images from obfuscated/transformed images.

FIG. 4 is a flowchart of example operations for deploying a trained image transform model and a trained image recovery model for CDR.

FIG. 5 depicts an example computer system with an image transform model, an image recovery model, an adversarial discriminator, and a model trainer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

As malicious actors develop more sophisticated techniques for image steganography, image CDR to remove malicious hidden data becomes increasingly challenging. Existing techniques for image CDR typically involve image resizing, application of filters, and image transcoding. However, sophisticated attackers may be able to add hidden malicious payloads to image pixel data that bypasses these techniques. The present disclosure leverages a generative Artificial Intelligence (AI)-based approach to train two models-a first neural network (“image transform model”) to transform image pixel data so as to obfuscate potentially hidden data while minimizing distortion with the original image, and a second neural network (“image recovery model”) that is able to recover the original image when the output of the first neural network is too distorted. Training the image transform model and the image recovery model uses a set of known malicious images comprising malicious payloads encoded with image steganography. The malicious payloads and the attack type for each malicious image are additionally known, allowing for recovery of the malicious payloads from known malicious images according to the corresponding attack type and validation that the recovered malicious payloads are correct.

In a first training stage, each known malicious image is input to the image transform model alongside a random bitstring that is independently randomly sampled for each input. The random bitstring ensures that the image transform model is learning perturbations of images and not exact images. A set of first transformed images output by the image transform model are input to a malicious image parser that leverages the known attack types to determine whether the malicious payloads can be recovered from the transformed images. The first transformed images are given recoverable or non-recoverable labels according to the success of the malicious image parser, and the first transformed images are then input to an adversarial discriminator that attempts to predict whether malicious payloads were recoverable from each transformed image. Based on the differences between the predictions of the adversarial discriminator and the labels obtained using the malicious image parser, loss is backpropagated through the adversarial discriminator and the image transform model. In a second training stage, internal parameters of the trained image transform model are fixed. Once again, a random bitstring is independently randomly sampled for each known malicious image and each known malicious image is input to the trained image transform model alongside the corresponding random bitstring to obtain second transformed images. The image recovery model is then trained on the second transformed images to recover the original known malicious images.

The resulting trained image transform model obfuscates hidden malicious payloads that were previously added to images using image steganography, and this capability is enhanced by the ensemble training of the image transform model with the adversarial discriminator. Moreover, in instances where the transformed images are not interpretable (i.e., do not visually resemble original images), the image recovery model can be used to recover the original images for subsequent display.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

“Hidden” data refers to potentially malicious data that does not alter an image sufficiently to arouse suspicion by visual inspection. Hidden data can be engineered to evade detection techniques such as the F5 algorithm, frequency domain analysis, etc.

### Example Illustrations

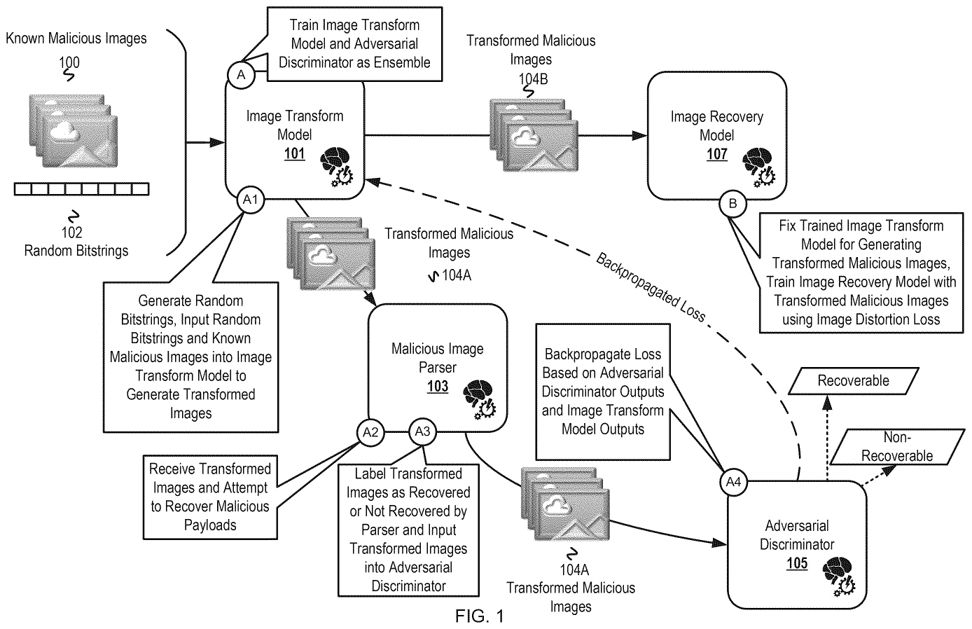

FIG. 1 is a schematic diagram of an example system for training an image transform model and an image recovery model for transforming images to obfuscate hidden malicious payloads and recovering original images from transformed images. In a first stage of training, an image transform model 101 is trained as an ensemble with an adversarial discriminator 105. Known malicious images 100 and random bitstrings 102 are input to the image transform model 101 to obtain transformed malicious images 104A. A malicious image parser 103 (e.g., an off-the-shelf tool) attempts to extract malicious payloads from the transformed malicious images 104A and labels each image with a “recoverable” or “non-recoverable” label. An adversarial discriminator 105 then predicts whether the transformed malicious images 104A are recoverable, and a combination loss of both the adversarial discriminator 105 and the image transform model 101 is backpropagated through the adversarial discriminator 105 and the image transform model 101. In a second stage of training, the image transform model 101 that has now been trained is fixed and used to generate transformed malicious images 104B from the known malicious images 100 and additional ones of the random bitstrings 102. The image recovery model 107 is then trained to recover the known malicious images 100 using image distortion loss between the known malicious images 100 and outputs of the image recovery model 107 resulting from inputting the transformed malicious images 104B.

FIG. 1 is annotated with a series of letters A, A1-A4, and B. Each stage represents one or more operations. Stage A is subdivided into sub-stages A1-A4 representing a more detailed perspective of operations at this stage. Stages A and B refer to the first and second training stages, respectively, mentioned in the foregoing. Although these stages are ordered for this example, the stages illustrate one example to aid in understanding this disclosure and should not be used to limit the claims. Subject matter falling within the scope of the claims can vary from what is illustrated.

At stage A, the image transform model 101 is trained as an ensemble with the adversarial discriminator 105. The transformed malicious images 104A output by the image transform model 101 are used as inputs to the adversarial discriminator 105 as part of the ensemble architecture. For the purposes of the present disclosure, the known malicious images 100 refer to the image pixel data for images and not image metadata (e.g., image dimensions, compression type, camera settings, etc.) and image headers (e.g., image type, file version, file size, header offsets, etc.). Image metadata and image headers can be handled for CDR using other cybersecurity components. Other embodiments can transform the image metadata and image headers as well using the image transform model 101.

The details for stage A described at stages A1-A4 occur for each batch of the known malicious images 100 and corresponding batch of the transformed malicious images 104A within a training epoch for the image transform model 101. These operations continue in batches until training termination criteria are satisfied, i.e., that a threshold number of batches/epochs has occurred, that training/testing/validation error are sufficiently low, that internal parameters of the image transform model 101 and the adversarial discriminator 105 converge across training iterations, etc.

At stage A1, the image transform model 101 (or other training component) generates the random bitstrings 102. For instance, each bit in the random bitstrings 102 can be 0 or 1 with equal probability. In embodiments where the image transform model 101 accepts variably size inputs and the known malicious images 100 have variable sizes, the size of each of the random bitstrings 102 can scale with the size of the corresponding one of the known malicious images 100. For instance, a random bitstring can have equal size or proportional size (e.g., ½ size, ⅓ size) to the corresponding malicious image. Each of the known malicious images 100 is concatenated with a corresponding one of the random bitstrings 102 at an input layer of the image transform model 101 before being input to additional layers of the image transform model 101. The use of random bitstrings ensures that the transformed malicious images 104A are not identical to the known malicious images 100 (i.e., that the image transform model 101 is not learning the identity map) because the loss function for the image transform model 101 is image distortion loss. This ensures that the transformed malicious images 104A are in fact obfuscations of the known malicious images 100 and are attempting to obfuscate hidden, potentially malicious payloads. Although depicted with a single label, the random bitstrings 102 comprise any bitstrings independently sampled whenever a model is invoked on one of the known malicious images 100.

At stage A2, the malicious image parser 103 receives the transformed malicious images 104A and attempts to recover the corresponding malicious payloads hidden in the known malicious images 100. Each of the transformed malicious images 104A is associated with an indicator of an attack type corresponding to the hidden malicious payload, and the malicious image parser 103 attempts to recover the malicious payload according to the attack type. For instance, for a least significant bit method attack, the malicious image parser 103 can extract least significant bits from image pixel data in the transformed malicious images 104A to attempt to recover the malicious payload. For a transform domain steganography attack, the malicious image parser 103 can apply a transformation into the domain where the malicious payload is hidden and extract the malicious payload therefrom. As new types of attacks for image steganography are identified and corresponding malicious images are added to the known malicious images 100, the malicious attack parser 103 can be updated with additional functionality to recover hidden malicious payloads from images of each additional attack type.

At stage A3, the malicious image parser 103 labels each of the transformed malicious images 104A as recovered or not recovered. The malicious image parser 103 compares the extracted malicious payloads and compares them to the “true” malicious payloads included in the known malicious images 100. If the extracted malicious payloads are identical or sufficiently similar (e.g., according to image distortion loss or by attempting to execute the attack using the extracted malicious payload), a “recovered”/“recoverable” label is assigned. Otherwise a “not recovered”/“non-recoverable” label is given. Additionally or alternatively, the malicious image parser 103 can determine whether the extracted malicious payloads are able to carry out the desired attack, for instance by simulating the attack in a sandbox environment. Once labeling is complete, the malicious image parser 103 inputs the transformed malicious images 104A into the adversarial discriminator 105.

At stage A4, the adversarial discriminator 105 outputs confidence values that each of the transformed malicious images 104A are recoverable. Loss based on outputs of the adversarial discriminator 105 and outputs of the image transform model 101 is then backpropagated through the ensemble of the adversarial discriminator 105 and the image transform model 101. The loss is computed as a combination loss for the image transform model 101 and the adversarial discriminator 105, e.g., as a simple average or weighted average of the respective losses. The image transform model 101 uses an image distortion loss computed according to the formula:

$$loss = \frac{1}{N} {\sum }_{i = 1}^{N} {( {I}_{o r i g i n a l ( i )} - {I}_{transforme d ( i )} )}^{2} ,$$

where

$${\{ {I}_{o r i g i n a l ( i )} \}}_{i = 1}^{N}$$

are the pixel values of the original malicious image and

$${\{ {I}_{transforme d ( i )} \}}_{i = 1}^{N}$$

are the pixel values of the transformed image. The adversarial discriminator 105 uses a binary cross-entropy loss computed according to the formula:

$$loss = - [ y log ( p ) + ( 1 - y ) log ( 1 - p ) ] ,$$

where y is the ground truth “recoverable” or “non-recoverable” label obtained using the malicious image parser 103 and p is the confidence value of recoverability output by the adversarial discriminator 105. Other losses that promote image similarity and correct classifications for the image transform model 101 and the adversarial discriminator, respectively, are additionally anticipated. The loss (e.g., the simple or weighted average of the loss computed with the above formulae) can be backpropagated using stochastic gradient descent.

At stage B, the training component fixes the internal parameters of the image transform model 101 that is now trained, uses the image transform model 101 to generate the transformed malicious images 104B, and trains the image recovery model 107 with the transformed malicious images 104B and image distortion loss. To generate the transformed malicious images 104B, the training component samples new ones of the random bitstrings 102 before inputting the random bitstrings 102 and corresponding ones of the known malicious images 100 into the image transform model 101 to obtain the transformed malicious images 104B as output. Training of the image recovery model 107 also uses image distortion loss according to the above formula, using pixels of images output by the image recovery model 107 instead of pixels of transformed images.

The training operations described in reference to FIG. 1 are performed by one or more training components (“trainers”) that are not explicitly depicted for space/clarity and manage obtaining/labelling training data, model maintenance (e.g., initialization of internal parameters, model storage/deployment), loss backpropagation, and any other additional operations related to training.

The image transform model 101, the image recovery model 107, and the adversarial discriminator 105 each comprise 2-dimensional convolutional neural networks (CNNs). These CNNs can comprise one or more 2-dimensional convolutional layers, batch normalization layers, activation layers, adaptive pooling layers, linear layers, etc. arranged interchangeably. More generally, these models can comprise any neural networks configured to take corresponding inputs and produce corresponding outputs.

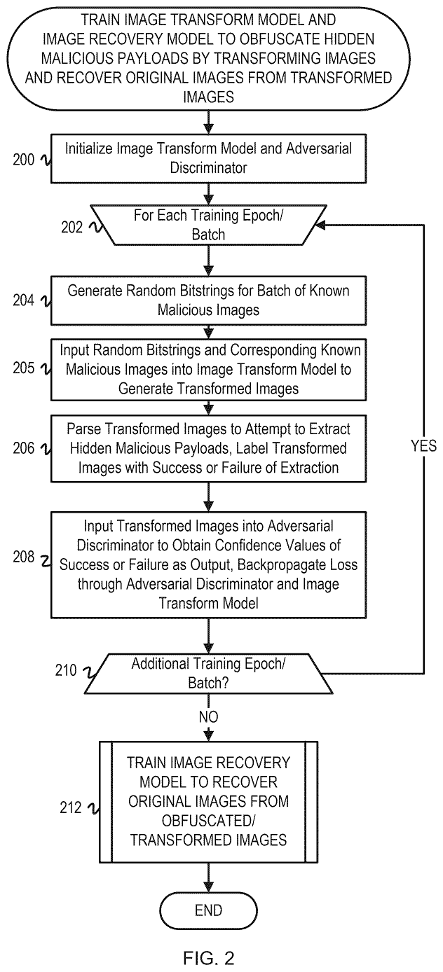

FIGS. 2-4 are flowcharts of example operations. The example operations are described with reference to a training component (“trainer”), an image transform model (“transform model”), and image recovery model (“recovery model”), a malicious image parser (“parser”), and an adversarial discriminator (“discriminator”) for consistency with the earlier figure and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for training an image transform model and an image recovery model to obfuscate hidden malicious payloads by transforming images and recovering original images from the transformed images. FIG. 2 assumes that a trainer has collected training data comprising known malicious images having malicious payloads hidden via image steganography, and each known malicious image is associated with the hidden malicious payloads and indicators of the corresponding attack types used for image steganography to hide the malicious payloads (e.g., spatial domain steganography, transform domain steganography, compressed domain steganography, least significant bit steganography, pixel value differencing steganography, random embedding steganography, style transfer-based steganography, etc.).

At block 200, the trainer initializes the transform model and the adversarial discriminator. For instance, the trainer can randomly initialize internal parameters at layers of the transform model and the adversarial discriminator. A random distribution for initializing internal parameters can be chosen according to known distributions that are effective for corresponding neural network architectures and the random distribution can be scaled accordingly.

At block 202, the trainer begins iterating through training epochs and batches of training data (i.e., known malicious images). At block 204, the trainer generates random bitstrings for the batch of known malicious images. For instance, the random bitstrings can have entries that are sampled from {0,1} uniformly at random. Each random bitstring for a distinct known malicious image is sampled independently.

At block 205, the trainer inputs the random bitstrings and corresponding known malicious images into the transform model (i.e., invokes the transform model on the random bitstrings and corresponding known malicious images) to generate transformed images as output.

At block 206, the parser parses the transformed images to attempt to extract the corresponding hidden malicious payloads. The parser then compares the extracted malicious payloads with the ground truth malicious payloads in the training data and labels each of the transformed images with indications of whether the extraction was a success or failure (i.e. “recoverable” or “non-recoverable”). The parser attempts to extract the hidden malicious payloads from the transformed images according to the corresponding attack type. The parser can emulate behavior of malicious attackers when attempting to extract hidden malicious payloads for each attack type. Whether the extraction was successful can be determined by comparing the extracted malicious payloads with the ground truth malicious payloads and/or by attempting to emulate the attack using the extracted malicious payloads (e.g., in a sandbox environment).

At block 208, the trainer inputs the transformed images into the discriminator (i.e., invokes the discriminator on the transformed images) to obtain confidence values of success or failure of malicious payloads extraction as output. The trainer then backpropagates loss through the discriminator and the transform model as part of training for the current batch. The loss is computed as a combination of image distortion loss applied to the transformed images output by the transform model and the original images and binary cross entropy loss applied to the confidence values of success (“recoverable”) or failure (“non-recoverable”) output by the discriminator and the ground truth labels generated by the parser. This loss is backpropagated through internal layers of the transform model and the discriminator as an ensemble, e.g., using stochastic gradient descent.

At block 210, the trainer determines whether there is an additional training epoch/batch. The trainer applies training termination criteria to determine whether there is an additional training epoch/batch, for instance, whether a threshold number of epochs/batches has elapsed, whether training/testing/validation loss is sufficiently low, whether internal parameters of the transform model/discriminator ensemble converge across training iterations, etc. If there is an additional training epoch/batch according to the training termination criteria, operational flow returns to block 202. Otherwise, operational flow proceeds to block 212.

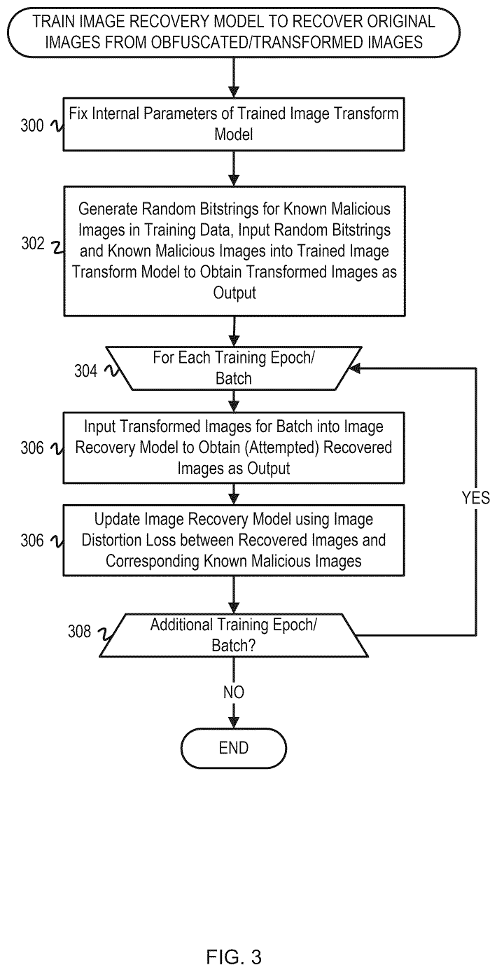

At block 212, the trainer trains the recovery model to recover the original images (i.e., the known malicious images) from obfuscated/transformed images. The trainer fixes the (now trained) transform model to generate the obfuscated/transformed images for training. These obfuscated/transformed images are distinct from the obfuscated/transformed images used to train the ensemble of the transform model/discriminator because the transform model is now trained. The operations at block 212 are described in greater detail in reference to FIG. 3.

FIG. 3 is a flowchart of example operations for training an image recovery model to recover original images from obfuscated/transformed images. At block 300, the trainer fixes the internal parameters of the trained transform model. The trained transform model has been trained to obfuscate hidden malicious payloads in images so that malicious attackers are not able to recover the hidden malicious payloads for executing a malicious attack.

At block 302, the trainer generates random bitstrings for known malicious images in training data. Each random bitstring is sampled independently and has a one-to-one correspondence with a known malicious image. The trainer then inputs the random bitstrings and corresponding known malicious images into the trained transform model (i.e., invokes the trained transform model on the random bitstrings and corresponding known malicious images) to obtain transformed images as output. The expectation is that a malicious attacker is not able to subsequently recover malicious payloads from the transformed images.

At block 304, the trainer begins iterating through training epochs/batches. At block 306, the trainer inputs the transformed images for the current batch into the recovery model (i.e., invokes the recovery model on the transformed images for the current batch) to obtain attempted recovered images as output. The recovery model is configured to output an image of the same size as input images and can be additionally configured to handle variably-sized image inputs and produce corresponding variably-sized images as output.

At block 306, the trainer updates the recovery model using image distortion loss between the recovered images and corresponding known malicious images in the training data. The loss is backpropagated through the recovery model and not further backpropagated through the trained transform model.

At block 308, the trainer determines whether there is an additional training epoch/batch. The trainer determines whether the is an additional training epoch/batch according to training termination criteria as described in the foregoing. If there is an additional training epoch/batch according to the training termination criteria, operational flow returns to block 304. Otherwise, the operational flow in FIG. 3 is complete.

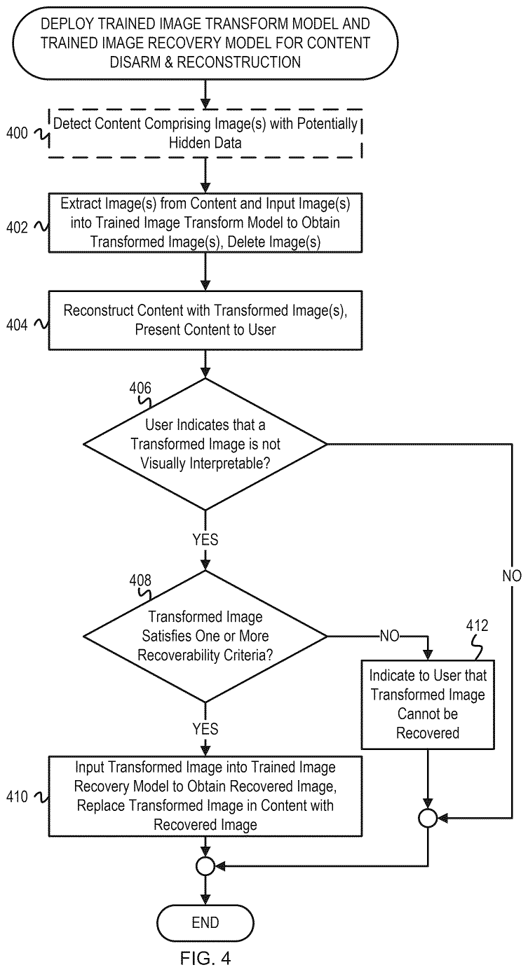

FIG. 4 is a flowchart of example operations for deploying a trained image transform model and a trained image recovery model for CDR. The trained transform model has been trained to obfuscate hidden data in images that are potentially malicious, and the trained recovery model has been trained to recover original images from transformed images output by the trained transform model.

At block 400, a cybersecurity component detects content comprising an image(s) with potentially hidden data. For instance, the trained transform model can be monitoring Hypertext Transfer Protocol (HTTP) responses from untrusted websites (e.g., Hypertext Markup Language (HTML) documents in HTTP responses), software-as-a-service (SaaS) application network traffic payloads for network traffic communicated to and from monitored endpoint devices, PDF documents stored on endpoint devices, etc. The HTTP responses can be intercepted prior to being rendered in web browsers. The trained transform model can be deployed on one or more firewalls maintaining cybersecurity for endpoint devices across an organization. Block 400 is depicted with a dashed outline to indicate that detecting content comprising images with potentially hidden data occurs independently of the remaining operations in FIG. 4 and can occur as part of a larger cybersecurity pipeline for CDR, data loss prevention, etc. For the example in FIG. 4, the intended destination of the content is an endpoint device of a user.

At block 402, the cybersecurity component extracts the image(s) (i.e., pixel data in the image(s)) from the content and inputs the image(s) into the trained transform model (i.e., invokes the trained transform model on the image(s)) to obtain a transformed image(s). For instance, the image transform model can extract images indicated by <img> tags in HTML documents. The image transform model then deletes the image(s) from the content to avoid potential execution of hidden malicious payloads. The image transform model maintains a pointer/indicator for a location(s) where the image(s) was deleted for subsequent insertion of a transformed image(s) during CDR.

At block 404, the cybersecurity component reconstructs the content with the transformed image(s) and presents the content to the user. For instance, the image transform model can insert the transformed image(s) at HTML <image> tags where the corresponding image(s) was deleted and then can render the resulting HTML document in a web browser of the user.

At block 406, the image transform model (or other user experience component) determines whether the user indicates that a transformed image is not visually interpretable (i.e., is dissimilar to the original image). For instance, a web browser where CDR was applied can have a user interface (UI) element indicating that CDR has occurred for potentially malicious images and the UI element can comprise a field where the user can indicate that an image is not visually interpretable. “Visually interpretable,” although a subjective evaluation by the user, generally means that a transformed image does not resemble what the original image was meant to represent and/or is not decipherable by the user. If the user indicates that the transformed image is not visually interpretable, operational flow proceeds to block 408. Otherwise, the operational flow in FIG. 4 is complete.

At block 408, the image transform model determines whether the transformed image satisfies one or more recoverability criteria. The one or more recoverability criteria can comprise whether a maliciousness score of a corresponding website is below a threshold score, whether a type of the content is not on a list of suspicious content types, etc. The recoverability criteria ensure that recovering the image(s) will not expose the user to a malicious attack. If the transformed image satisfies the one or more recoverability criteria, operational flow proceeds to block 410. Otherwise, operational flow proceeds to block 412.

At block 410, the cybersecurity component inputs the transformed image into the trained recovery model (i.e., invokes the trained recovery model on the transformed image) to obtain a recovered image as output. The cybersecurity component then replaces the transformed image in the content with the recovered image. The cybersecurity component replaces the transformed image with the recovered image at locations according to the indicators/pointers described in the foregoing for where the original image was removed. The web browser or other UI component can then render the updated content comprising the recovered image, e.g., in a web browser of the user. The operational flow in FIG. 4 is complete.

At block 412, the cybersecurity component (or other UI component) indicates to the user that the transformed image cannot be recovered. The cybersecurity component can additionally provide a reason that the transformed image cannot be recovered, e.g., that the source of the transformed image is not trusted.

### Variations

A “random bitstring” can alternatively be referred to or implemented as a “random number sequence” or, more generally, as any additional input to a neural network that adds randomness to enable obfuscation of hidden malicious payloads in images. Although the foregoing description refers to using random bitstrings as inputs to image transform models alongside corresponding images, random bitstrings can be inserted at other layers of image transform models (e.g., intermediate layers). For instance, random bitstrings can be used to randomly perturb an internal convolutional layer of an image transform model, random perturb an output linear layer, etc.

The foregoing description refers to training an image transform model and adversarial discriminator as an ensemble, fixing the trained image transform model to generate training data for an image recovery model, and then using the generated training data to train the image recovery model. Other embodiments can use different training regimes. For instance, the image transform model, image recovery model, and adversarial discriminator can all be trained as an ensemble using a combination loss function of image distortion loss for the image transform model and image recovery model and binary cross-entropy loss function for the adversarial discriminator. Moreover, other types of loss functions are additionally anticipated.

Any of the operations applied to “images” in the foregoing can alternatively be described as being applied to pixel data in images. A “transformed” image can alternatively be referred to as a “transformation” of an image.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 402, 404, 406, 408, 410, and 412 can be performed in parallel or concurrently across detected content comprising images. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

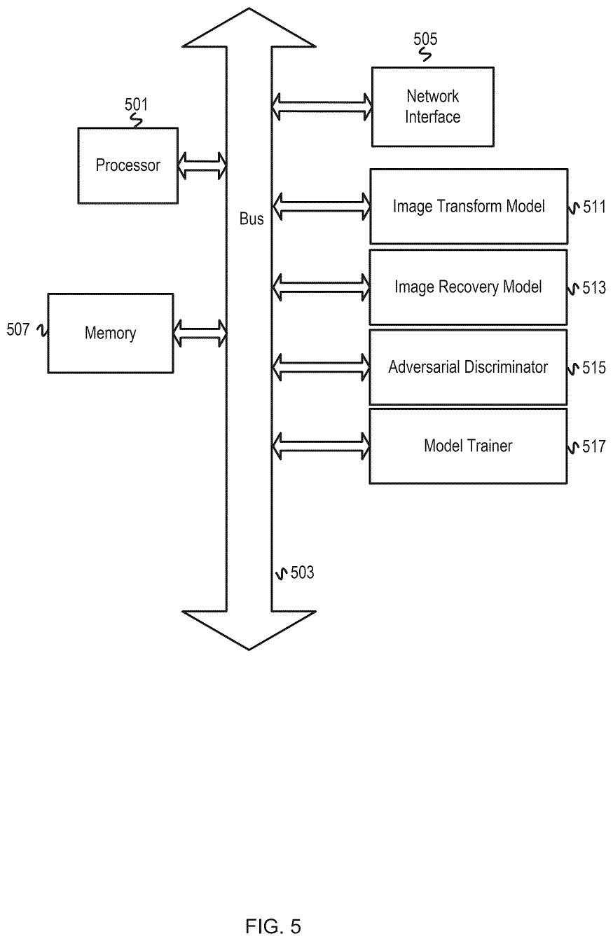

FIG. 5 depicts an example computer system with an image transform model, an image recovery model, an adversarial discriminator, and a model trainer. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an image transform model 511, an image recovery model 513, an adversarial discriminator 515, and a model trainer 517. In a first training stage, the model trainer 517 trains the image transform model 511 and the adversarial discriminator 515 as an ensemble using known malicious images and corresponding random bitstrings as training data. Transformed images output by the image transform model 511 are labelled as “recoverable” or “non-recoverable” using a malicious image parser (not depicted) attempting to recover corresponding hidden malicious payloads. These labels inform the loss function of the adversarial discriminator 515, and this loss function is combined with an image distortion loss function for the image transform model 511 when backpropagating loss for the ensemble of the image transform model 511 and the adversarial discriminator 515 during training. In a second training stage, the model trainer 517 fixes internal parameters of the now trained image transform model 511, samples additional random bitstrings, and inputs the random bitstrings and corresponding known malicious images into the image transform model 511 to generate additional transformed images. The model trainer 517 the trains the image recovery model 513 with the additional transformed images as inputs using image distortion loss with the original known malicious images in the training data. The now trained image transform model 511 and the image recovery model 513 are then deployed for CDR of images detected in content (e.g., in HTTP responses). Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
extracting pixel data from an image file comprising potentially hidden data; and
transforming the pixel data to obfuscate the potentially hidden data, wherein transforming the pixel data comprises,
generating a random number sequence; and
invoking a first neural network on the pixel data and the random number sequence to generate a transformation of the pixel data, wherein the first neural network is trained to minimize distortion of output transformations of pixel data and corresponding input pixel data.

2. The method of claim 1, wherein the first neural network was trained as an ensemble with a second neural network, wherein the second neural network predicts whether a malicious attacker can recover hidden data from transformations of pixel data output by the first neural network.

3. The method of claim 2, wherein the ensemble of the first neural network and the second neural network is trained with image distortion loss between inputs and outputs of the first neural network and binary cross entropy loss between outputs of the second neural network and corresponding ground truth labels for whether transformations of pixel data are recoverable.

4. The method of claim 1, wherein invoking the first neural network on the pixel data and the random number sequence comprises inputting the pixel data at an input layer of the first neural network and inputting the random number sequence at at least one of an intermediate layer and the input layer of the first neural network.

5. The method of claim 1, further comprising replacing the pixel data in the image file with the transformation of the pixel data for content disarm and reconstruction.

6. The method of claim 1, further comprising, based on determining that the transformation of the pixel data is dissimilar to the pixel data, inputting the transformation of the pixel data into a second neural network to recover the pixel data.

7. The method of claim 1, wherein the first neural network comprises a convolutional neural network.

8. A non-transitory machine-readable medium having program code stored thereon, the program code comprising instructions to:
train a first neural network to obfuscate hidden malicious payloads in images, wherein the instructions to train the first neural network comprise instructions to, for each batch of images in training data having hidden malicious payloads,
invoke the first neural network on the batch of images to obtain transformed images;
invoke a second neural network on the transformed images to obtain predictions of whether the hidden malicious payloads are recoverable from each of the transformed images; and
backpropagate a first loss and a second loss through the second neural network and the first neural network as an ensemble, wherein the first loss comprises a loss between the batch of images and the transformed images, wherein the second loss comprises a loss between predictions obtained from invoking the second neural network and ground truth labels for whether the hidden malicious payloads are recoverable from each of the transformed images.

9. The machine-readable medium of claim 8, wherein the program code further comprises instructions to deploy the trained first neural network for content disarm and reconstruction of detected images in content.

10. The machine-readable medium of claim 8, wherein the instructions to invoke the first neural network on the batch of images comprise instructions to, for each image in the batch of images,
generate a random bitstring;
concatenate the random bitstring and the image; and
input the concatenated random bitstring and the image into the first neural network.

11. The machine-readable medium of claim 8, wherein the first loss comprises an image distortion loss, wherein the second loss comprises a binary cross-entropy loss.

12. The machine-readable medium of claim 8, wherein the program code further comprises instructions to train a third neural network to recover original images from additional transformed images output by the trained first neural network.

13. The machine-readable medium of claim 8, wherein the first neural network and the second neural network comprise convolutional neural networks.

14. The machine-readable medium of claim 8, wherein the program code further comprises instructions to generate the ground truth labels for whether the hidden malicious payloads are recoverable from each of the transformed images based, at least in part, on attack types for the hidden malicious payloads.

15. An apparatus comprising:
a processor; and
a machine-readable medium having instructions stored thereon that are executable by the processor to cause the apparatus to,
train a first neural network to obfuscate hidden malicious payloads in images, wherein the instructions to train the first neural network comprise instructions to, for each batch of images having hidden malicious payloads in training data,
invoke the first neural network on the batch of images to obtain transformed images;
invoke a second neural network on the transformed images to obtain predictions of whether hidden malicious payloads are recoverable from each of the transformed images; and
backpropagate a first loss and a second loss through the second neural network and the first neural network as an ensemble, wherein the first loss comprises a loss between inputs and outputs of the first neural network, wherein the second loss comprises a loss for predictions by the second neural network against ground truth labels.

16. The apparatus of claim 15, wherein the first loss comprises a loss between the batch of images and the transformed images, wherein the second loss comprises a loss between predictions obtained from invoking the second neural network and ground truth labels for whether the hidden malicious payloads are recoverable from each of the transformed images.

17. The apparatus of claim 16, wherein the first loss comprises an image distortion loss, wherein the second loss comprises a binary cross-entropy loss.

18. The apparatus of claim 15, wherein the machine-readable medium further has stored thereon instructions executable by the processor to cause the apparatus to deploy the trained first neural network for content disarm and reconstruction of detected images in content.

19. The apparatus of claim 15, wherein the instructions to invoke the first neural network on the batch of images comprise instructions executable by the processor to cause the apparatus to, for each image in the batch of images,
generate a random bitstring;
concatenate the random bitstring and the image; and
input the concatenated random bitstring and the image into the first neural network.

20. The apparatus of claim 15, wherein the machine-readable medium further has stored thereon instructions executable by the processor to cause the apparatus to train a third neural network to recover original images from additional transformed images output by the trained first neural network
